(19) United States
(12) Patent Application Publication
(10) Pub. No.: US 2021/0310620 A1
(43) Pub. Date: Oct. 7, 2021

(54) Channel Covers with Air Gaps and Interchangeable Light Modifiers

(71) Applicant: Elemental LED, Inc., Reno, NV (US)

(72) Inventor: Matthew John, Reno, NV (US)

(21) Appl. No.: 17/216,805

(22) Filed: Mar. 30, 2021

Related U.S. Application Data
(60) Provisional application No. 63/003,503, filed on Apr. 1, 2020.

(51) Int. Cl. F21K 9/69; F21S 4/28; F21V 3/06; F21Y 115/10

(52) U.S. Cl. CPC F21K 9/69; F21Y 2115/10; F21V 3/0625; F21S 4/28

(57) ABSTRACT

Channel covers for linear lighting channels and luminaires including these covers are disclosed. The channel covers have central open areas, also referred to as air gaps. These central open areas may increase refraction and, therefore, diffusion when light from LED light engines passes through them. The channel covers may include other features that modify light rays passing through them. For example, inner and outer surfaces of the channel covers may be curved to produce a lens effect. In some cases, the central open area may be filled with a liquid or a gel that has light-modifying properties. In other cases, the cover may include a slot, usually adjacent to the central open area. The slot accommodates a filter. The liquid, gel, or filter may include particles to diffuse light or other elements, like a phosphor, to absorb, modify, and re-emit the light.

### CROSS-REFERENCE TO RELATED APPLICATIONS

This application claims priority to, and the benefit of, U.S. Provisional Patent Application No. 63/003,503, filed Apr. 1, 2020. The contents of that application are incorporated by reference herein in their entirety.

### TECHNICAL FIELD

The invention relates to linear lighting, and more particularly to channel covers with air gaps.

### BACKGROUND

Linear lighting is a particular type of lighting based on light-emitting diodes (LEDs) in which a number of LED light engines are mounted on an elongate, narrow printed circuit board (PCB), usually spaced from one another at a regular pitch or spacing. By connecting segments of the PCB during manufacturing, linear lighting can be made in arbitrarily long lengths. The PCB may be either flexible or rigid.

One of the most popular ways of using linear lighting is to install it in a channel and cover it with a cover. The result is a finished luminaire suitable for installation in a variety of locations.

There are a number of situations in which it is desirable to modify the light emitted by a strip of linear lighting. For example, a typical LED light engine has a beam angle or width of about 120°, and it can be desirable to produce a narrower beam of light for some applications. It can also be desirable to diffuse the emitted light, so that the resulting light appears as a continuous line or bar, instead of a series of bright spots that are created by each of the LED light engines. Traditionally, the cover of an LED channel performs some of these functions, providing at least some diffusion for the emitted light.

### BRIEF SUMMARY

Aspects of the invention relate to channel covers for linear lighting channels. The channels have central open areas, also referred to as air gaps. These central open areas may increase refraction and, therefore, diffusion when light from LED light engines passes through them. In some cases, the channel covers may include other features that modify light rays passing through them. For example, inner and outer surfaces of the channel covers may be curved to produce a lens effect.

In some cases, the central open area may be filled with a liquid or a gel that has light-modifying properties. In other cases, the cover may include a slot, usually adjacent to the central open area. The slot accommodates a filter. The liquid, gel, or filter may include particles to diffuse light or other elements, like a phosphor, to absorb, modify, and re-emit the light.

Another aspect of the invention relates to luminaires that include the kinds of covers described above.

Other aspects, features, and advantages of the invention will be set forth in the description that follows.

### BRIEF DESCRIPTION OF THE DRAWING FIGURES

The invention will be described with respect to the following drawing figures, in which like numerals represent like features throughout the invention, and in which:

FIG. 1 is a partially sectional perspective view of a channel with a strip of linear lighting installed and a cover according to an embodiment of the invention;

FIG. 2 is a cross-sectional view of the channel and cover of FIG. 1;

FIG. 3 is a cross-sectional view of a channel according to another embodiment of the invention installed on a channel;

FIG. 4 is a cross-sectional view of a cover according to yet another embodiment of the invention installed on a channel;

FIG. 5 is a cross-sectional view of a co-extruded channel according to a further embodiment of the invention shown installed on a channel;

FIG. 6 is a cross-sectional view of the channel and cover of FIG. 2, shown filled with a liquid;

FIG. 7 is a cross-sectional view of the channel and cover of FIG. 2, filled with a polymer or gel; and

FIG. 8 is a cross-sectional view of a cover with a filter according to yet another further embodiment of the invention, shown installed on a channel.

### DETAILED DESCRIPTION

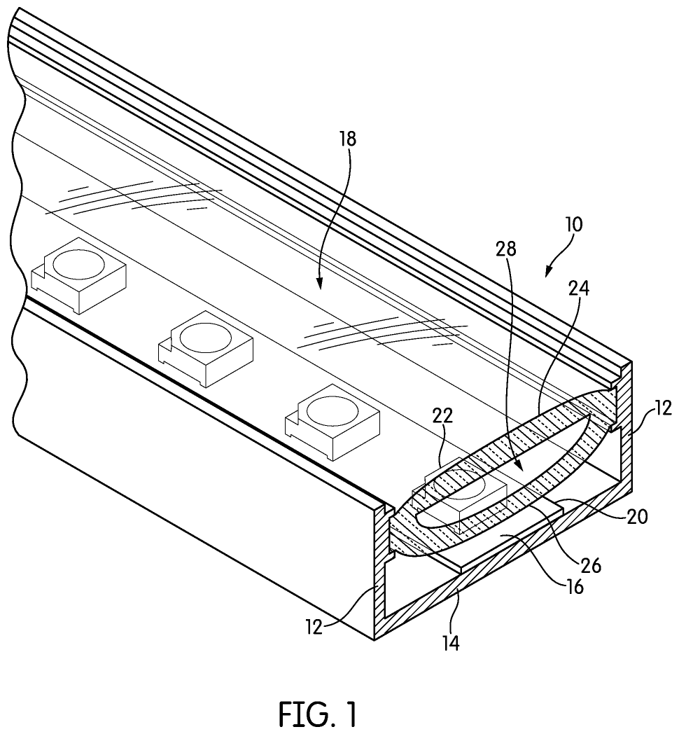

FIG. 1 is a partially sectional perspective view of a channel, generally indicated at 10. The channel 10 has a pair of generally vertical sidewalls 12 that arise from a bottom 14. In the illustrated embodiment, a strip of linear lighting 16 is installed on the bottom 14 of the channel 10. A cover 18 is installed overtop the channel 10.

The strip of linear lighting 16 can be considered typical of linear lighting in general: it has a printed circuit board (PCB) 20, on which LED light engines 22 are disposed, spaced from one another at a regular spacing or pitch. The PCB 20 may be either rigid or flexible.

As the term is used here, “light engine” refers to an element in which one or more light-emitting diodes (LEDs) are packaged, along with wires and other structures, such as electrical contacts, that are needed to connect the light engine to a PCB. LED light engines may emit a single color of light, or they may include red-green-blue (RGBs) that, together, are capable of emitting a variety of different colors depending on the input voltages. If the light engine is intended to emit “white” light, it may be a so-called “blue pump” light engine in which a light engine containing one or more blue-emitting LEDs (e.g., InGaN LEDs) is covered with a phosphor, a chemical compound that absorbs the emitted blue light and re-emits either a broader or a different spectrum of wavelengths. In the illustrated embodiment, the light engines are surface-mount devices (SMDs) soldered to the PCB 20, although other types of light engines may be used. Neither the particular type of LED light engine 22 nor the overall characteristics of the linear lighting 16 are critical, and they may vary widely from embodiment to embodiment.

The linear lighting 16 is installed flat on the bottom 14 of the channel 10 and thus emits light upward, presumably with a beam angle that may be, e.g., 120-150°. As can be seen in FIG. 1, the cover 18 has a specific shape that may help to diffuse the light emitted by the linear lighting 16.

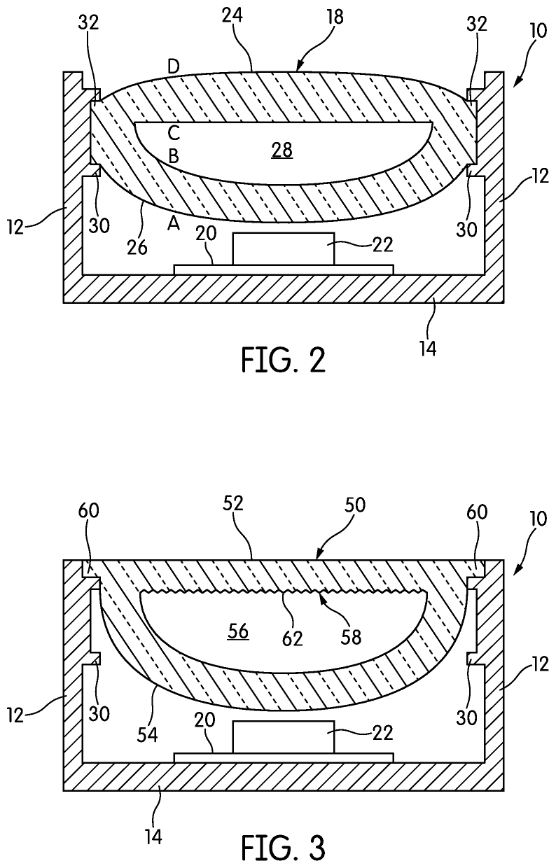

More particularly, as can be appreciated from FIG. 1, as well as from the cross-sectional view of FIG. 2, the cover 18 has a generally bi-convex outer shape in cross-section, i.e., the top edge 24 and the bottom edge 26 of the cover 18 both bulge outward, although in this embodiment, they differ in curvature, with the top edge 24 being somewhat flatter than the bottom edge. The curvature of the top edge 24 and the bottom edge 26 may be the same or different, they may be spherical or non-spherical, and in general, the cover 18 may or may not be designed with the properties of a lens or lenses. If the cover 18 is designed to act as a lens, the shapes of the edges 24, 26 may be designed to achieve a specific purpose, e.g., a specific beam width of the emitted light.

The cover 18 is not completely solid, although it may be in some embodiments, as will be described below in more detail. Instead, it includes a central open area 28, also referred to as an air gap 28, between the top edge 24 and the bottom edge 26. Essentially, the thickness of the cover material is interrupted by the central open area 28. The central open area 28 may serve a specific purpose: it may improve the ability of the cover 18 to diffuse light that is transmitted through it.

As those of skill in the art will appreciate, according to Snell's law, a ray of light refracts—i.e., bends—at the interface between two materials of different refractive indices. In most embodiments, the channel 10 is in air, refractive index nearly 1.0, and the cover 18 is made of a plastic with a refractive index in the range of about 1.4-1.6, with higher indices of refraction generally being desirable in this application. Given that, light rays emitted by the light engines 22 face four separate air/plastic or plastic/air interfaces to escape the channel. For reference, these interfaces are labeled A-D in FIG. 2. Interface A exists at the boundary between air and the lower surface 26 of the cover 18. Interface B exists as the light ray enters the open area 28 in the center of the cover 18. Interface C exists as the light ray leaves the air-filled open area 28 and enters the plastic of the cover 18 once more. Interface D exists at the boundary between the top surface 24 of the cover 18 and the surrounding air.

Thus, the cover 18 provides greater opportunities for refraction than a cover without a central open area 28, which has the result of providing more opportunity for light emitted from the light engines 22 to diffuse. However, as those of skill in the art will also appreciate, not every emitted light ray passes through the cover. Because of the principle of total internal reflection, based on its angle of incidence, any light ray may be reflected back at any of the interfaces. Light rays that are reflected back into the previous medium may reflect off another interface, or structures inside the channel, and ultimately escape the channel 10, or they may be scattered.

The above description assumes that the linear lighting 16 is mounted on the bottom 14 and emits light directly up. That need not be the case for the cover 18, or a cover like it, to have a beneficial effect on diffusion. For example, in other embodiments, a strip of linear lighting 16 could be installed on an inner face of one of the sidewalls 12 of the channel 14. Alternatively, the linear lighting may be of the type referred to as “side emitting” which emits light not upward, but laterally. In these cases, the linear lighting would likely reflect from one or more surfaces before reaching the cover 18 and its interfaces.

The channel 10 would typically be made with features that complement the cover 18. At its most basic, that means that the channel 10 and cover 18 would be designed to engage one another. As can be seen in FIGS. 1 and 2, the channel 10 defines retaining structure 30 that extends inwardly from each sidewall 12. In the illustrated embodiment, the retaining structure 30 comprises a pair of tall, shallow channels that engage lateral edges 32 of the cover 18. In other embodiments, the engagement between the channel 10 and the cover 18 may be by means of any kind of complementary structures, although it is helpful if the cover 18 can either be snapped into place or slid into place.

Channels 10 may be particularly adapted for covers with central open spaces 28 in other ways. For example, the greater opportunities for refraction may make it possible to make a channel 10 shorter, with less space between the channel 10 and a cover 18 than a channel designed for a more conventional cover.

There are many possible variations on the structure of the cover 18 described above. The following describes but a few of them. FIG. 3 is a cross-sectional view similar to the view of FIG. 2. The channel 10 is the same in FIG. 3 as in FIG. 2. However, the structure of the cover 50 is different from that of the cover 18.

Specifically, the cover 50 is plano-convex in overall shape, with the planar side 52 of the cover 50 facing outward and the convex side 54 facing the LED light engines 22. Like the cover shown in FIGS. 1 and 2, the cover 50 has a central open area 56 that extends along its length. The central open area 56 is somewhat larger than the central open area 28 described above. Additionally, the central open area 56 has an upper inner wall 58 that has ridges or serrations 62. The ridges or serrations 62 may further diffuse light that is transiting from the central open area 56 to the top edge 52. Although the ridges or serrations 62 of FIG. 3 are shown along the top edge 52, the entire sidewall of the central open area 56 may have ridges in other embodiments.

As may also be evident from FIG. 3, the manner in which the cover 50 engages with the sidewalls 12 of the channel 10 is different than that described above. The lateral edges 60 of the cover 50 rest atop the retaining structure 30, rather than within it. Thus, the cover 50 is retained largely by gravity and, in some cases, by a tight fit. The manner in which the cover 50 engages the channel 10 is not critical, and may vary considerably.

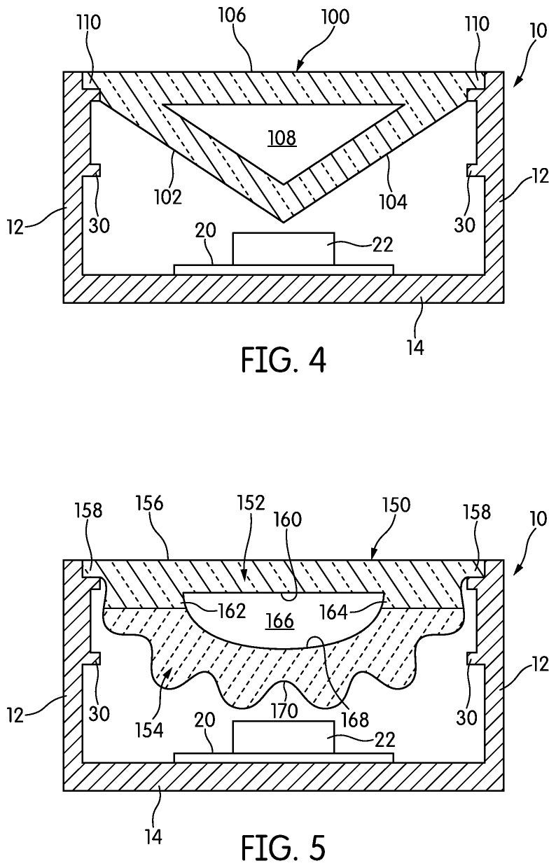

FIG. 4 is a cross-sectional view illustrating another embodiment of a channel cover, generally indicated at 100, shown as installed on a channel 10. The cover 100 of FIG. 4 has a hollow triangular cross-section, arranged with the two angled faces 102, 104 within the channel 10 and a flat face 106 as the outer surface of the cover 100. The central open area 108 is triangular, although it need not always be. The lateral side edges 110 of the cover 100 rest on the retaining structure 30. In addition to the additional interfaces for refraction that are provided by the central open area 108, the cover 100 may further diffuse the light by providing some prismatic effects.

As was noted briefly above, the covers 10, 50, 100 described above, and other covers according to embodiments of the invention, are made of a material with a higher refractive index than that of air. That material is usually plastic, but in some cases, it may be glass. Covers 10, 50, 100 of this type are typically extruded from a thermoplastic, although they may also be molded or cast, especially in shorter lengths. Traditional polycarbonate and acrylic plastics are suitable for these kinds of covers 10, 50, 100, as are polyurethanes. Other materials may be used.

Covers may also be co-extruded, molded, cast, or otherwise manufactured using multiple materials. For example, covers may be made with one material that is more transparent and another material that is more opaque. Covers may also be made with areas of different refractive indices, or gradations in index of refraction.

FIG. 5 is one example of a co-extruded cover, generally indicated at 150, shown as installed on a channel 10. The cover 150 has a first portion 152, made of a first material, and a second portion 154 made of a second material. The material of the first portion 152 and the material of the second portion 154 could differ in a variety of ways, including refractive index, opacity, additives, color, etc. While portions of this description may assume that the first portion 152 and the second portion 154 are co-extruded, as was noted above, other manufacturing methods may be used. For example, if the first portion 152 and the second portion 154 of the cover are made separately, they may be bonded together by adhesive or solvent bonding to make the cover 150.

In the illustrated embodiment, the first portion 152 has a flat outer surface 156 which faces out of the channel 10. The first portion 152 also carries the lateral edges 158 that rest on the retaining structure 30. On the channel-facing surface 160 of the first portion 152, there are two thickened pads 162, 164. The second portion 154 extends from and between the two thickened pads 162, 164, arcing to form a central open area 166 between the first portion 152 and the second portion 154. The second portion has an arcuate inner surface 168 bordering the central open area 166 and an outer surface 170 that is both arcuate and undulating facing the LED light engines 22. Of course, FIG. 5 is only one example of a co-extruded cover 150 or, more generally, a cover with portions of different optical or mechanical properties.

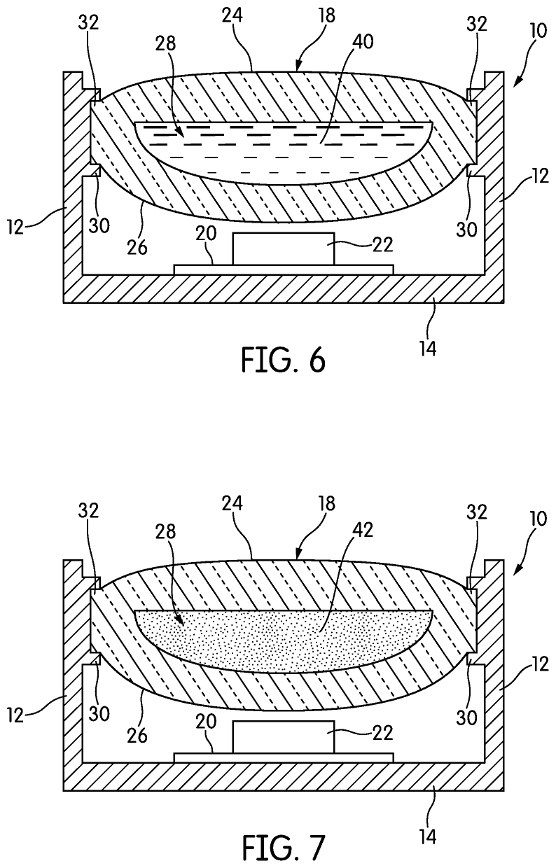

There are other ways to selectively change or modify the optical properties of covers according to embodiments of the invention. In many instances, a central open area 28 may be filled with a substance having different properties. FIG. 6 is a cross-sectional view similar to the view of FIG. 2. In the view of FIG. 2, the central open area 28 of the cover 18 is filled with a liquid 40. In some cases, the liquid 40 may be provided for refractive effect, while in other cases, the liquid may serve a filtering effect. For example, the liquid 40 may be colored to color the light output of the light engines 22. The liquid 40 may also have suspended particles or objects, like stars, moons, or other such things, that will throw shadows for decorative effect.

FIG. 7 is a view similar to FIG. 6 in which the central open area 28 of the cover 18 is filled with a caulk or gel 42. A caulk or gel 42 may provide much the same potential benefits as a liquid 40, with less potential for failure and spillage. As with the liquid 42, a caulk or gel 42 may have suspended particles or objects, either for refractive or for decorative effect. If the intent is to diffuse emitted light, particles such as titanium dioxide microspheres may be included in a desired concentration.

While the cover 18 of FIGS. 1-2 is shown in FIGS. 6-7 for purposes of illustration, any of the covers 18, 50, 100, 150 described here may be filled with a liquid, a gel, or another such substance in order to produce a gradation in optical properties, a diffusing effect, a decorative effect, or for some other purpose. Of course, it may be possible to achieve the desired effect without filling the entire central open area 28. It may also be desirable in some embodiments to fill the central open area 28 in layers or portions, which each layer having properties different from the last.

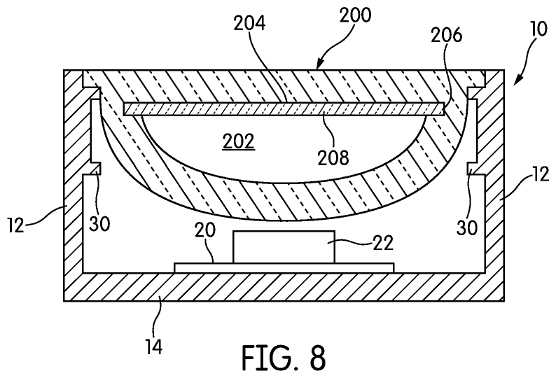

The embodiments of FIGS. 6 and 7 are not the only way in which open areas or air gaps in a cover may be used to modify light. FIG. 8 is a cross-sectional view similar to the view of FIG. 3, with a cover, generally indicated at 200, that is similar to the cover 50 of FIG. 3. The cover 200 is shown mounted on a channel 10. The cover 200 has a central open area 202. Adjacent to the top inner edge 204 of the central open area 202, the cover 200 defines a slot 206. Inserted into the slot 206 in the illustrated embodiment is a filter 208.

The filter 208 is rectangular in cross section and is elongate and thin. The filter 208 may perform any or all of the functions ascribed to the liquid 40 or gel 42 above, but is typically a solid piece of plastic or glass, and its positioning within a dedicated slot may make it easier to insert, remove, and replace as needed. For example, such a filter 208 could be used to quickly change the color, diffusion, or other properties of the light emitted by the LED light engines in a way that can be easily changed by removing the filter 208 from the slot 206 and inserting another filter.

The filter 208 itself may be made of the same material as the cover 200, or it may be made of a different material, with either a similar or a dissimilar refractive index to that of the cover 200. Like the liquid 40 or gel 42, it may include particles or other additives to improve diffusion, or it may function solely as a color filter. For example, the filter 208 could be used to change the color temperature of emitted light.

In some cases, added elements like a gel 42 or a filter 208 may be loaded with a phosphor and used to create a remote phosphor luminaire. Remote phosphor luminaires are those in which the LED light engines are not topped with a phosphor; instead, they emit their usual color of unmodified light (e.g., blue) and that emitted light encounters a phosphor to change its spectrum somewhere else before leaving the luminaire. Compared with luminaires that include typical LED light engines 22, remote phosphor luminaires often last longer, largely because the phosphor is farther away from the LED light engines and thus is exposed to less heat. To that end, while the filter 208 is thin and rectilinear in the illustrated embodiment, it could be thicker and contoured in other embodiments. Alternatively, the contours of the cover 200 could be modified to work with a remote phosphor.

In addition to the added opportunity for refraction and diffusion that they provide and their potential uses for remote phosphor and other similar applications, covers 200 with slots 206 for filters 208 have another potential advantage: they may simplify inventory and make it easier to change the properties of a cover 200, and thus the luminaire, very quickly. For example, the correlated color temperature (CCT) of a luminaire may be changed by adding a filter 208 that blocks certain wavelengths of light, regardless of the CCT of the LED light engines 22. In a remote phosphor luminaire, a filter 208 that has phosphor suspended in it to produce light of a specific CCT can be easily swapped for a filter 208 that has phosphor suspended in it to produce light of a different CCT. Similarly, a cover 10 may be filled with a liquid 40 or gel 42 with specific light-altering properties, capped, and shipped.

For these reasons, aspects of the invention may relate to methods for selecting or changing the light-emitting properties of a luminaire. These methods may include adding a filter, a liquid, or a gel with at least one specific light-modifying property to a cover 10, 50, 150, 200 with a central open area 28. A further step of curing the liquid 40 or gel 42 or sealing those elements within the central open area 28 using a fitted endcap would typically be used.

More generally, methods for assembling luminaires that include a channel 10 and a cover 10, 50, 150, 200 are also within the scope of the invention. Usually, these methods would begin by connecting the PCB 20 of a strip of linear lighting 16 to power. This is typically done by soldering lead wires onto defined solder pads on the PCB 20, but various types of solderless connectors may also be used. Meanwhile, a channel 10 and the cover 10, 50, 150, 200 are cut to the desired length. In order to ensure that the channel 10 and the cover 10, 50, 150, 200 are the same length, these components may be cut at the same time, with the cover 10, 50, 150, 200 installed in the channel 10. A powered rotary saw, a band saw, or any other appropriate tool may be used for cutting. If needed, cleaning and de-burring steps may be performed after cutting. The strip of linear lighting 16 is then installed in the channel 10, typically by using pressure-sensitive adhesive on the reverse of the strip of linear lighting 16. Once the strip of linear lighting 16 is installed, the cover 10, 50, 150, 200 may be filled or a filter added as described above before it is seated on the channel 10. Endcaps are used to secure the ends of the channel 10.

While the invention has been described with respect to certain embodiments, the description is intended to be exemplary, rather than limiting. Modifications and changes may be made within the scope of the invention, which is defined by the appended claims.

What is claimed is:

1. A cover for a linear lighting channel, comprising:
an upper surface and a lower surface separated by a thickness of a material, the thickness of material defining a central open area that does not contain the material, edges of the thickness of material adapted to engage the linear lighting channel;
wherein the cover has a refractive index higher than that of air and has a substantially constant cross-sectional shape over its length.

2. The cover of claim 1, wherein one or both of the upper surface and the lower surface are curved.

3. The cover of claim 2, wherein the lower surface is curved between the edges.

4. The cover of claim 3, wherein the lower surface is convex.

5. The cover of claim 2, wherein the upper surface is curved between the edges.

6. The cover of claim 5, wherein the upper surface is convex.

7. The cover of claim 1, wherein one or both of upper and lower inner surfaces bordering the central open area are curved.

8. The cover of claim 1, wherein one or both of upper and lower inner surfaces bordering the central open area are ridged.

9. The cover of claim 1, wherein:
the upper surface is flat;
the lower surface is convexly curved; and
one or both of upper and lower inner surfaces bordering the central open area are curved.

10. The cover of claim 1, further comprising a slot disposed within or proximate to the central open area.

11. The cover of claim 10, further comprising a filter disposed within the slot.

12. The cover of claim 1, wherein the open central area is filled with a liquid or a gel, the liquid or the gel having at least one optical property different from the material of the cover.

13. A luminaire, comprising:
a channel having a bottom, sidewalls arising from the bottom, and cover-retaining structure;
one or more strips of linear lighting installed in the channel; and
a cover installed over the channel, the cover engaging the cover-retaining structure and including an upper surface and a lower surface separated by a thickness of a material, the thickness of material defining a central open area that does not contain the material;
wherein the cover has a refractive index higher than that of air and has a substantially constant cross-sectional shape over its length.

14. The luminaire of claim 13, wherein one or both of the upper surface and the lower surface are curved.

15. The luminaire of claim 13, wherein one or both of upper and lower inner surfaces bordering the central open area are curved.

16. The luminaire of claim 13, wherein one or both of upper and lower inner surfaces bordering the central open area are ridged.

17. The luminaire of claim 13, further comprising a slot disposed within or proximate to the central open area.

18. The luminaire of claim 17, further comprising a filter disposed within the slot.

19. The luminaire of claim 17, wherein the open central area is filled with a liquid or a gel, the liquid or the gel having at least one optical property different from the material of the cover.
